(19) United States
(12) Patent Application Publication
(10) Pub. No.: US 2025/0387710 A1
(43) Pub. Date: Dec. 25, 2025

(54) METHOD FOR CONTROLLING GAME PICTURE, APPARATUS FOR CONTROLLING GAME PICTURE, AND ELECTRONIC DEVICE

(71) Applicant: NETEASE (HANGZHOU) NETWORK CO., LTD., Hangzhou (CN)

(72) Inventor: Weinan LI, Hangzhou (CN)

(21) Appl. No.: 18/877,311

(22) PCT Filed: Apr. 28, 2023
(86) PCT No.: PCT/CN2023/091539

§ 371 Date: Dec. 20, 2024

(30) Foreign Application Priority Data
Jun. 21, 2022 (CN) 202210706916.3

(51) Int. Cl. A63F 13/577; A63F 13/525

(52) U.S. Cl. CPC A63F 13/577; A63F 13/525

(57) ABSTRACT

A method for controlling a game picture, including: in response to detecting that a controlled virtual object in a first scenario picture is blocked by a first obstacle, determining a target position point in the first scenario picture; generating a virtual straight line based on a mapping point of the target position point in a virtual scenario and a position of a virtual camera in the virtual scenario; determining an intersection point of the virtual straight line and a plane that includes the controlled virtual object; determining the intersection point as a position point on the plane; and controlling, in response to detecting that a second obstacle is not present between the virtual camera and the position point, the virtual camera to move based on the mapping point until the controlled virtual object in a second scenario picture captured by the virtual camera is not blocked.

### CROSS-REFERENCE TO RELATED APPLICATIONS

The present disclosure is a 371 national phase application of PCT Application PCT/CN2023/091539 filed Apr. 28, 2023, which claims priority to Chinese Patent Application No. 202210706916.3 titled “METHOD FOR CONTROLLING GAME PICTURE, APPARATUS FOR CONTROLLING GAME PICTURE, AND ELECTRONIC DEVICE” and filed on 21 Jun. 2022, the entire contents of both of which applications are hereby incorporated by reference for all purposes.

### TECHNICAL FIELD

The present disclosure relates to the technical field of games, and particularly relates to a method for controlling a game picture, an apparatus for controlling a game picture, and an electronic device.

### BACKGROUND

In a game with a 3D perspective, a virtual camera generally photographs a game scenario in a wide viewing angle, so that a player, when participating in the game, not only can see a virtual character controlled by the player, but also can observe global information, such as terrain and environment, of the game scenario, to facilitate decision making by the player. When photographing the game scenario in a wide viewing angle, the virtual camera needs to keep a long distance from the virtual character; when the virtual character is blocked by a model in the scenario, the virtual camera will move to another side of the model to photograph the virtual character through a close-up lens; and when the virtual character is not blocked, the virtual camera will return to a farther position. This method will lead to frequent switching between a telephoto lens and a close-up lens, thereby resulting in instability of game pictures displayed on a terminal device, and bringing a negative visual experience to the player. In addition, when the lens is suddenly zoomed in, it is difficult for the player to observe the global information of the game scenario in real time, which affects decision making on the game by the player, brings poor game experience to the player, extends execution duration of the terminal device, and consumes power of the terminal device.

It should be noted that the information disclosed in the above “Background” is only used to enhance understanding of the background of the present disclosure, and therefore may include information that does not constitute relevant technologies known to those of ordinary skills in the art.

### SUMMARY

The present disclosure provides a method, an apparatus, and an electronic device for controlling a game picture to adjust a taking lens smoothly.

According to a first aspect, the present disclosure provides a method for controlling a game picture. The method includes: in response to detecting that a controlled virtual object in a first scenario picture is blocked by a first obstacle, determining a target position point in the first scenario picture, where the controlled virtual object is controlled through a terminal device, and the first scenario picture is captured in a virtual scenario by a virtual camera in a game and displayed by a graphical user interface of the terminal device; generating a virtual straight line based on a mapping point of the target position point in the virtual scenario and a position of the virtual camera in the virtual scenario; determining an intersection point of the virtual straight line and a plane that comprises the controlled virtual object; determining the intersection point as a specified position point on the plane that comprises the controlled virtual object is located, where a connection line between the position of the virtual camera in the virtual scenario and a position of the controlled virtual object forms a preset angle with the plane that comprises the controlled virtual object; determining whether a second obstacle is present between the virtual camera and the specified position point; and controlling, in response to detecting that the second obstacle is not present, the virtual camera to move based on the mapping point, where the controlled virtual object in a second scenario picture captured by the virtual camera after movement is not blocked, and the second obstacle comprises the first obstacle or an obstacle other than the first obstacle.

According to a second aspect, the present disclosure provides a system, comprising one or more memories collectively containing one or more programs, and one or more processors, where the one or more processors are configured to, individually or collectively, perform the operations in the above for controlling a game picture.

According to a third aspect, the present disclosure provides one or more non-transitory computer-readable storage media containing, in any combination, computer program code that, when executed by a computer system, performs the operations in the above method for controlling a game picture.

### BRIEF DESCRIPTION OF DRAWINGS

To more clearly describe technical solutions of specific embodiments of the present disclosure or relevant technologies, drawings to be used in the description of the specific embodiments or the relevant technologies will be briefly introduced below. Apparently, the drawings described below are some embodiments of the present disclosure. For those of ordinary skills in the art, other drawings may also be obtained based on these drawings without creative work.

FIG. 1 is a schematic diagram of a scenario picture of a controlled virtual object captured by a virtual camera from a long distance provided in one of the embodiments of the present disclosure;

FIG. 2 is a schematic diagram of a scenario picture of a controlled virtual object captured by a virtual camera from a very small distance provided in one of the embodiments of the present disclosure;

FIG. 3 is a flowchart of a method for controlling a game picture provided in one of the embodiments of the present disclosure;

FIG. 4 is a schematic diagram of an observation point provided in one of the embodiments of the present disclosure;

FIG. 5 is a schematic diagram of a target position point in a first scenario picture provided in one of the embodiments of the present disclosure;

FIG. 6 is a schematic diagram of a specified position point on a plane where a controlled virtual object is located provided in one of the embodiments of the present disclosure;

FIG. 7 is a schematic diagram of a target position point in another first scenario picture provided in one of the embodiments of the present disclosure;

FIG. 8 is a schematic diagram of a specified position point on a plane where another controlled virtual object is located provided in one of the embodiments of the present disclosure;

FIG. 9 is a schematic diagram of a candidate position point in position point selection information provided in one of the embodiments of the present disclosure;

FIG. 10 is a schematic diagram of a virtual camera moving to a preset position provided in one of the embodiments of the present disclosure;

FIG. 11 is a schematic diagram of a method for determining a mapping point provided in one of the embodiments of the present disclosure;

FIG. 12 is a schematic diagram of a method for determining a virtual straight line provided in one of the embodiments of the present disclosure;

FIG. 13 is a schematic structural diagram of an apparatus for controlling a game picture provided in one of the embodiments of the present disclosure; and

FIG. 14 is a schematic structural diagram of an electronic device provided in one of the embodiments of the present disclosure.

### DETAILED DESCRIPTION

In order to make the objectives, technical solutions, and advantages of embodiments of the present disclosure clearer, the technical solutions in the present disclosure will be clearly and completely described below with reference to the drawings. Apparently, the described embodiments are some, instead of all, of the embodiments of the present disclosure. All other embodiments obtained by those skilled in the art based on the embodiments of the present disclosure without creative work are encompassed within the scope of protection of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

The described method, apparatus, and electronic device for controlling a game picture operate as follows: determine, in response to a controlled virtual object in a first scenario picture being blocked by a first obstacle, a target position point from a first scenario picture, where the controlled virtual object is controlled through a terminal device, and the first scenario picture is captured in a virtual scenario by a virtual camera in a game and displayed by a graphical user interface of the terminal device; generate a virtual straight line based on a mapping point of the target position point in a virtual scenario and a position of the virtual camera in the virtual scenario; determine an intersection point of the virtual straight line and a plane that comprises the controlled virtual object; determine the intersection point as a specified position point on the plane that comprises the controlled virtual object, where a connection line between the position of the virtual camera in the virtual scenario and a position of the controlled virtual object forms a preset angle with the plane that comprises the controlled virtual object; determine whether a second obstacle is present between the virtual camera and the specified position point; and control, in response to the second obstacle not being present, the virtual camera to move based on the mapping point, where the controlled virtual object in a second scenario picture captured by the virtual camera after movement is not blocked, and the second obstacle comprises the first obstacle or an obstacle other than the first obstacle.

In the disclosed embodiments, a target position point is first determined from a scenario picture, and a mapping point of the target position point located in a virtual scenario is obtained. Subsequently, based on the mapping point, a specified position point is determined on the plane where the controlled virtual object is located. When no obstacle is present between the virtual camera and the specified position point, the virtual camera is controlled to move based on the mapping point, to prevent the controlled virtual object in the scenario captured by the virtual camera from being blocked. When the controlled virtual object is blocked, the camera is adjusted smoothly, enabling players to continuously observe not only the controlled virtual object but also the global information of the scenario. The disclosed approach improves the player's game experience, enhances the stability of the game picture displayed on the terminal device, reduces execution duration of the terminal device, and saves power consumption of the terminal device.

In a game with a 3D perspective, a virtual camera is generally equipped with a virtual scenario for photographing in a wide viewing angle, that is, the virtual camera needs to have better combat and gameplay experience only when it is kept far away from a player model to capture a scenario picture with a larger field of view. At the same time, the virtual camera generally moves based on a virtual character (also referred to as a controlled virtual object) controlled by a player, and the player observes the virtual character through the scenario picture.

When the controlled virtual object is blocked by other models in the virtual scenario, such as a wall model, a usual approach is directly moving the virtual camera to an edge of the wall model, so that the virtual camera and the controlled virtual object are located on a same side of the wall model, to ensure that the controlled virtual object appears in the captured scenario picture, and the player can find a position of the controlled virtual object through the scenario picture.

However, for some very important raid barrier games, since each barrier will be designed with complex terrain where many low wall models and stone models are present, the controlled virtual object is usually forced to approach an obstacle to avoid enemy skills. In this case, the obstacle blocks the controlled virtual object, thereby resulting in failure to observe the controlled virtual object through the scenario picture. In this case, the virtual camera is generally moved to the vicinity of the controlled virtual object, to prevent the obstacle from blocking the controlled virtual object. The virtual camera photographs the controlled virtual object at close range, thereby resulting in failure to observe global information of barriers by the player through the scenario picture, affecting decision making on the game by the player, and bringing poor game experience to the player.

When the controlled virtual object moves in the vicinity of an obstacle, the virtual camera will frequently switch between far and nearby positions depending on whether the controlled virtual object is blocked by the obstacle, thereby resulting in frequent switching between scenario pictures, and bringing negative visual experience to the player.

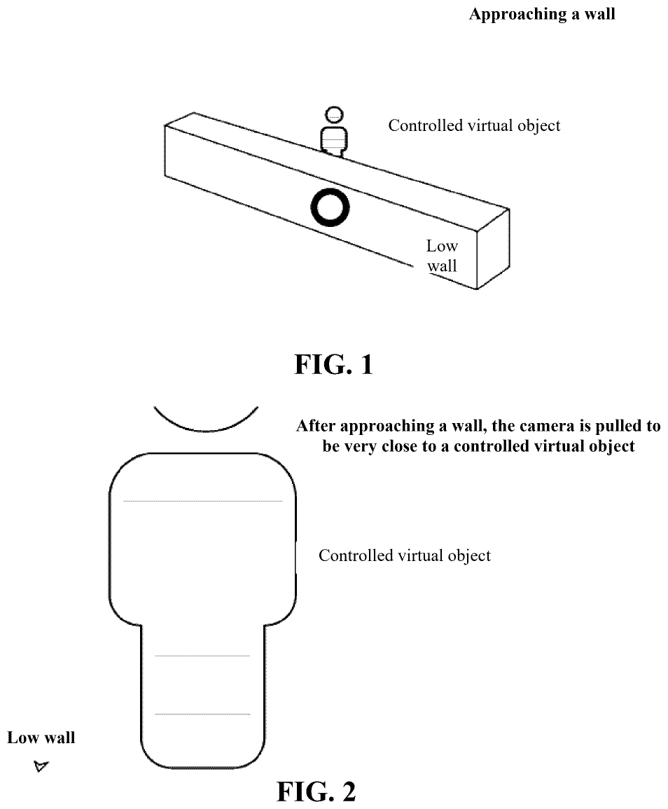

As an example, FIG. 1 is a scenario picture of a controlled virtual object captured by a virtual camera from a long distance. When the controlled virtual object approaches a low wall model, the controlled virtual object is blocked by the low wall model; the virtual camera will quickly move to the vicinity of the low wall at a position as shown by the circle in FIG. 1, and the virtual camera and the controlled virtual object are located on a same side of the low wall model. Since the virtual camera is very close to the controlled virtual object, the captured scenario picture is generally the picture shown in FIG. 2. The controlled virtual object occupies most display region of the scenario picture, and even the controlled virtual object cannot be completely displayed in the scenario picture, so that it is difficult for the player to observe global information of a virtual scenario through the scenario picture.

Based on the above description, embodiments of the present disclosure provide a method for controlling a game picture, an apparatus for controlling a game picture, and an electronic device. This technology can be applied to a process of photographing a game scenario or other virtual scenarios.

The method for controlling a game picture in one of the embodiments of the present disclosure may be run on a local terminal device or server. When the method for controlling a game picture runs on the server, the method can be implemented and executed based on a cloud interaction system, where the cloud interaction system includes a server and a client device.

In some embodiments, various cloud applications, such as a cloud game, can be run in the cloud interaction system. Taking the cloud game as an example, the cloud game refers to a game method based on cloud computing. In an operating mode of the cloud game, an operating body of a game program and a presenting body of the game picture are separated. The storage and operation of the method for controlling a game picture are completed on a cloud game server. The client device functions to receive data, transmit data, and present the game picture. For example, the client device may be a display device with data transmission function in the vicinity of the user side, such as a mobile terminal, a television set, a computer, or a palm computer. However, information processing is performed by a cloud game server in cloud. When playing a game, the player operates the client device to transmit an operating instruction to the cloud game server. The cloud game server runs the game based on the operating instruction, encodes and compresses data such as the game picture, returns the data to the client device through a network, and finally decodes the data and outputs the game picture through the client device.

In some embodiments, taking the game as an example, the local terminal device stores the game program, and is configured to present the game picture. The local terminal device is configured to interact with the player through a graphical user interface, that is, conventionally downloading, installing, and running the game program through an electronic device. The local terminal device may provide the graphical user interface to the player by various approaches, for example, by rendering and displaying on a display screen of a terminal or by holographic projection. For example, the local terminal device may include a display screen and a processor. The display screen is configured to present the graphical user interface. The graphical user interface includes the game picture. The processor is configured to run the game, generate the graphical user interface, and control display of the graphical user interface on the display screen.

The present disclosure provides a method for controlling a game picture, providing a graphical user interface through a terminal device, where the terminal device may be the aforementioned local terminal device, or may be the client device in the aforementioned cloud interaction system.

A graphical user interface is provided by the terminal device, and the graphical user interface may display interface contents, for example, a game scenario picture or a communication interaction window, based on the type of a started application program. In this embodiment, the graphical user interface displays a first scenario picture captured in the virtual scenario by the virtual camera in the game; the virtual scenario is a three-dimensional virtual scenario, and the virtual camera performs photographing in the virtual scenario, to obtain the above first scenario picture. During the game, the virtual camera generally has position and posture changes following the movement of the controlled virtual object controlled by the player, so that the captured first scenario picture contains the controlled virtual object, and so that the player can observe the position and environment where the controlled virtual object is located in real time. In addition, the player may further change picture contents of the first scenario picture based on relevant operating conditions and position and posture of the virtual camera.

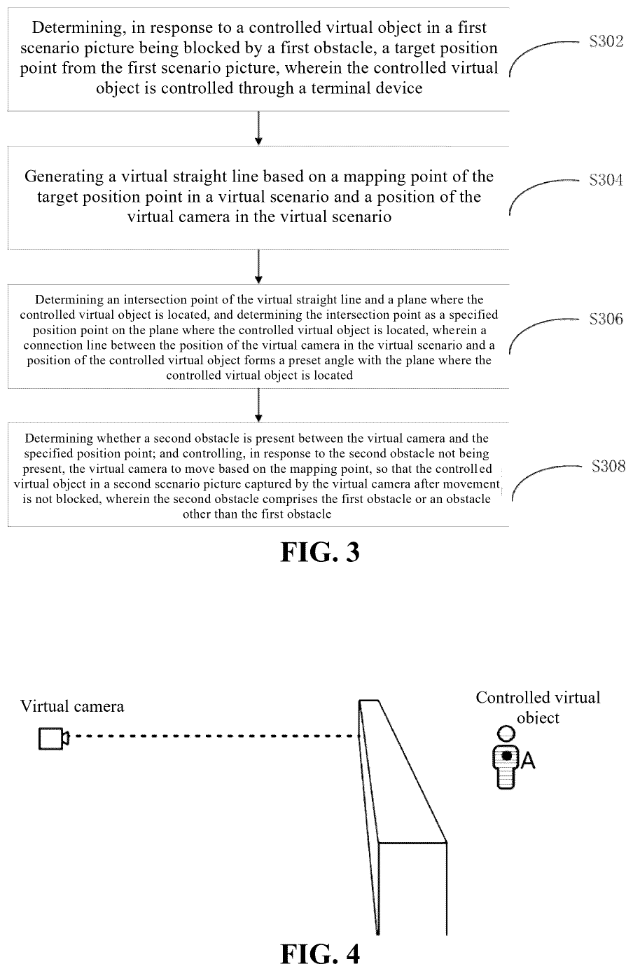

In order to facilitate understanding of this embodiment, a method for controlling a game picture disclosed in an embodiment of the present disclosure is first introduced in detail. As shown in FIG. 3, the method for controlling a game picture provides a graphical user interface through a terminal device, the graphical user interface displays: a first scenario picture captured in a virtual scenario by a virtual camera in a game; and the method includes the following steps:

Step S302: determining, in response to a controlled virtual object in the first scenario picture being blocked by a first obstacle, a target position point from the first scenario picture, where the controlled virtual object is controlled through the terminal device.

A player transmits a particular operation or instruction through the terminal device, thereby controlling the controlled virtual object to move or execute other actions. The above first obstacle may be a model, such as wall, tree, building, stone, mountain, or vegetation, in the virtual scenario.

In the virtual scenario, in addition to the controlled virtual object, there may also be models, such as walls, trees, buildings, stones, mountains, or vegetation. These models are all likely to block the controlled virtual object. When the controlled virtual object approaches one of these models, and the model is located between the controlled virtual object and the virtual camera, the model blocks the controlled virtual object. The model is the first obstacle mentioned above, and the controlled virtual object is not included in the first scenario picture. In some embodiments, an observation point may be determined on a model of the controlled virtual object. The observation point may be located on, e.g., the head or chest of the controlled virtual object, or may be a point at the exact center of the model of the controlled virtual object. The virtual camera forms a straight line with the observation point, and whether the straight line is truncated may be monitored in real time. If the straight line is truncated, it can be determined that the controlled virtual object is blocked. As an example, in FIG. 4, observation point A is located at a chest position of the controlled virtual object, and a straight line formed by the virtual camera and the observation point A is truncated by a low wall model. In this case, it may be considered that the controlled virtual object is blocked, and the low wall is the first obstacle. The position of the observation point may also be adjusted based on the shape and size of the model of the controlled virtual object.

Considering that the controlled virtual object is moving in the virtual scenario all along, and the environment where the controlled virtual object is located is also changing all along, whether the above straight line is truncated may be detected for each frame of the first scenario picture captured by the virtual camera, thereby determining whether the first obstacle is present between the virtual camera and the controlled virtual object in real time, that is, whether the controlled virtual object is blocked.

This embodiment is intended to find an appropriate movement path or an appropriate moving position point for the virtual camera, so that the controlled virtual object continues to appear in the scenario picture, and a large shooting angle of the scenario picture is maintained, thereby avoiding suddenly photographing the controlled virtual object by the virtual camera at close range. On this basis, in this embodiment, after the controlled virtual object is detected to be blocked by the first obstacle, the target position point is determined from the first scenario picture. The first scenario picture is a two-dimensional picture, corresponding to a two-dimensional coordinate system. In some embodiments, coordinates of one or more candidate position points may be pre-determined, and the target position point may be selected from the candidate position points, or the target position point may be determined based on the picture contents of the first scenario picture.

Step S304: generating a virtual straight line based on a mapping point of the target position point in the virtual scenario and a position of the virtual camera in the virtual scenario.

Step S306: determining an intersection point of the virtual straight line and a plane where the controlled virtual object is located, and determining the intersection point as a specified position point on the plane where the controlled virtual object is located, where a connection line between the position of the virtual camera in the virtual scenario and a position of the controlled virtual object forms a preset angle with the plane where the controlled virtual object is located.

Based on the mapping point of the target position point in the virtual scenario, the specified position point on the plane where the controlled virtual object is located is determined. In the virtual scenario, the plane where the controlled virtual object is located is pre-determined based on the position of the virtual camera.

The virtual scenario is a three-dimensional space, corresponding to a three-dimensional coordinate system. When the virtual camera photographs the virtual scenario, a mapping relationship between the three-dimensional coordinate system of the virtual scenario and the two-dimensional coordinate system of the first scenario picture can be obtained based on relevant parameters of the virtual camera. Based on this mapping relationship, the mapping point of the target position point in the virtual scenario can be obtained, and the mapping point is a three-dimensional position point in the virtual scenario.

Since the controlled virtual object is in the three-dimensional space of the virtual scenario, the controlled virtual object may pass through many planes in the three-dimensional space. In this embodiment, it is necessary to determine the plane where the controlled virtual object is located. The plane where the controlled virtual object is located needs to be determined based on the position of the virtual camera. For example, in the virtual space, the virtual camera forms a straight line with the controlled virtual object, and the plane where the controlled virtual object is located needs to form a certain angle with the straight line, or the plane where the controlled virtual object is located needs to form a certain angle with the straight line in a particular direction. For another example, a straight line is formed based on the position and orientation of the virtual camera, the plane where the controlled virtual object is located needs to form a certain angle with the straight line, or the plane where the controlled virtual object is located needs to form a certain angle with the straight line in a particular direction.

After the plane where the controlled virtual object is located is determined, the specified position point is determined on the plane based on the aforementioned mapping point. The specified position point corresponding to the mapping point may be determined based on a preset corresponding relationship; or the specified position point may be determined based on a relative position between the mapping point and the plane where the controlled virtual object is located; or the specified position point may be determined based on a relative position between the virtual camera, the mapping point, and the plane where the controlled virtual object is located.

In some embodiments, the straight line formed by the virtual camera and the controlled virtual object is perpendicular to the plane where the controlled virtual object is located. In this case, the plane where the controlled virtual object is located may be uniquely determined in the three-dimensional space of the virtual scenario.

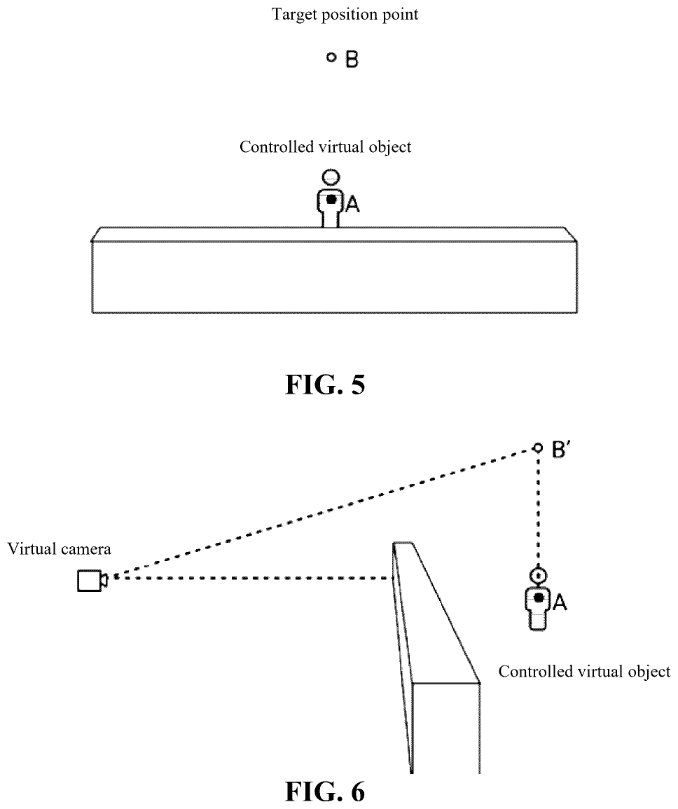

As an example, point B in FIG. 5 is the target position point in the first scenario picture. The mapping point of the target position point in the virtual scenario forms a straight line with the virtual camera. The straight line is as shown by the dotted line in FIG. 6. This straight line passes through the virtual camera and point B′; and the point B′ is an intersection point of the straight line and the plane where the controlled virtual object is located. Point A is an observation point located on the controlled virtual object, and a dotted line formed by the point A and the point B′ represents the plane where the controlled virtual object is located.

When no obstacle is present between the virtual camera and the specified position point, that is, the point B′, since the point B′is located on the plane where the controlled virtual object is located, it can be determined that no obstacle is present between the mapping point or position points around the mapping point and the controlled virtual object. On this basis, in this embodiment, the virtual camera is controlled to move based on the mapping point.

Step S308: determining whether a second obstacle is present between the virtual camera and the specified position point; and controlling, in response to the second obstacle not being present, the virtual camera to move based on the mapping point, so that the controlled virtual object in a second scenario picture captured by the virtual camera after movement is not blocked, where the second obstacle comprises the first obstacle or an obstacle other than the first obstacle.

In some embodiments, a straight line may be generated between the virtual camera and the specified position point, and whether the straight line is blocked is detected in the virtual scenario. If the straight line is blocked, it can be determined that the second obstacle is present between the virtual camera and the specified position point; and if the straight line is not blocked, it can be determined that the second obstacle is not present between the virtual camera and the specified position point.

Since the specified position point is located on the plane where the controlled virtual object is located, and the specified position point is determined based on the mapping point, when the second obstacle is not present between the virtual camera and the specified position point, it can be inferred that the virtual camera can photograph the controlled virtual object when the virtual camera is controlled to move based on the mapping point. At the same time, in this embodiment, the mapping point is a point mapped from the target position point determined in the first scenario picture to the three-dimensional space of the virtual scenario without reference to the position of the controlled virtual object. Therefore, generally, there is a certain distance between the mapping point and the controlled virtual object. On this basis, after the virtual camera is controlled to move based on the mapping point, the captured second scenario picture contains the controlled virtual object that is not blocked, and the virtual camera and the controlled virtual object satisfy a specified distance. The specified distance may be a minimum distance value, a distance between the virtual camera and the controlled virtual object is larger than or equal to the minimum distance value, the specified distance may also be a distance range, and the distance between the virtual camera and the controlled virtual object is within this distance range.

In some embodiments, a movement path may be generated based on a current position of the virtual camera and a position of the mapping point. The starting point of the movement path is the current position. The movement path may pass through the mapping point, or use the mapping point as the end point of the movement path; or the movement path may not pass through the mapping point, but an extension direction of the movement path is associated with the position of the mapping point. For example, if there is a small distance between the mapping point and the controlled virtual object, in this case, the movement path may be set in the vicinity of the mapping point and away from the position of the controlled virtual object, and the controlled virtual object may also be photographed at this position. In addition, the above specified distance may also be associated with the distance between the virtual camera prior to movement and the controlled virtual object. The specified distance may be equal to the distance between the virtual camera prior to movement and the controlled virtual object, or a distance range may be set based on the distance between the virtual camera prior to movement and the controlled virtual object, and the distance range is used as the specified distance.

The above method for controlling a game picture determines, in response to a controlled virtual object in a first scenario picture being blocked by a first obstacle, a target position point from the first scenario picture, where the controlled virtual object is controlled through a terminal device; generates a virtual straight line based on a mapping point of the target position point in a virtual scenario and a position of the virtual camera in the virtual scenario; determines an intersection point of the virtual straight line and a plane where the controlled virtual object is located, and determines the intersection point as a specified position point on the plane where the controlled virtual object is located, where a connection line between the position of the virtual camera in the virtual scenario and a position of the controlled virtual object forms a preset angle with the plane where the controlled virtual object is located; determines whether a second obstacle is present between the virtual camera and the specified position point; and controls, in response to the second obstacle not being present, the virtual camera to move based on the mapping point, so that the controlled virtual object in a second scenario picture captured by the virtual camera after movement is not blocked, where the second obstacle comprises the first obstacle or an obstacle other than the first obstacle.

In some embodiments, a target position point is first determined from a scenario picture, a mapping point of the target position point located in a virtual scenario is obtained, then a specified position point is determined on a plane where a controlled virtual object is located based on the mapping point, and when no obstacle is present between a virtual camera and the specified position point, the virtual camera is controlled to move based on the mapping point, so that this method can prevent the controlled virtual object in the scenario captured by the virtual camera from being blocked; and when the controlled virtual object is blocked, a taking lens is adjusted relatively smoothly, so that players not only can continue observing the controlled virtual object, but also can observe global information of the scenario, thereby improving their game experience, improving stability of a game picture displayed on a terminal device, reducing execution duration of the terminal device, and saving power consumption of the terminal device.

A specific implementation of determining the target position point from the first scenario picture will be further described in the following embodiments. In some embodiments, in response to the controlled virtual object in the first scenario picture being blocked by the first obstacle, the target position point is determined from the first scenario picture based on preset position point selection information, where the position point selection information records position information of at least one candidate position point in the first scenario picture.

Generally, scenario pictures captured by the virtual camera have an equal size. On this basis, the above position point selection information may record two-dimensional coordinates of at least one candidate position point, and a candidate position point is selected from the position point selection information. In the first scenario picture, a point corresponding to a two-dimensional coordinate of the candidate position point is determined as the above target position point. For example, if a scenario picture captured by the virtual camera has a length of 1920 px and a width of 1080 px, a lower left corner of the scenario picture is used as the origin of the two-dimensional coordinate system, the position point selection information may record position point information (960 px, 1000 px) of the candidate position point, and this position point is a point at an upper middle position in the scenario picture.

The above position point selection information may record position point information of a plurality of candidate position points. In this case, the plurality of candidate position points may be sorted, and a top-ranked candidate position point is selected preferentially as the target position point. If the selected target position point is processed in a way as that in the above embodiments to obtain the specified position point, a first obstacle is present between the specified position point and the virtual camera. In this case, a next candidate position point may be selected based on the rank as the target position point.

In the above embodiments, the target position point is determined based on the position point selection information, which is convenient and simple with a small calculation amount.

In some embodiments, the above candidate position point includes: a first position point located above the controlled virtual object, a second position point located between the controlled virtual object and the first position point, a third position point located on a left side of the controlled virtual object, and a fourth position point located on a right side of the controlled virtual object; the first position point, the second position point, the third position point, and the fourth position point are arranged from highest to lowest in terms of priorities of being determined as the target position point; and in response to the controlled virtual object in the first scenario picture being blocked by the first obstacle, the first position point with a highest priority is determined as the target position point.

It should be noted that the above first position point may be an absolute position point of the first scenario picture, that is, the first position point has a constant two-dimensional coordinate, and the first position point is located at an upper position of the first scenario picture; or the above first position point may be a relative position point relative to the controlled virtual object, the first position point is located in an upper part of the controlled virtual object, and the coordinate of the first position point is determined based on the position of the controlled virtual object. Likewise, the third position point and the fourth position point mentioned above may also be absolute position points of the first scenario picture, or may be relative position points relative to the controlled virtual object.

Based on the above priorities, when the controlled virtual object is blocked by the first obstacle, the first position point is first used as the target position point, and then the specified position point is obtained; if the second obstacle is not present between the specified position point and the virtual camera, the virtual camera is directly controlled to move; and if the second obstacle is present between the specified position point and the virtual camera, the second position point is used as the target position point. The above steps are repeated, by analogy, until the fourth position point is used as the target position point.

That is, if the second obstacle is present between the virtual camera and the specified position point, a next position point of the target position point is used as an updated target position point based on the priorities; the step of generating the virtual straight line based on the mapping point of the target position point in the virtual scenario and the position of the virtual camera in the virtual scenario continues to be executed, then the steps of determining the intersection point of the virtual straight line and the plane where the controlled virtual object is located, determining the intersection point as the specified position point on the plane where the controlled virtual object is located, where the connection line between the position of the virtual camera in the virtual scenario and the position of the controlled virtual object forms the preset angle with the plane where the controlled virtual object is located, and determining whether the second obstacle is present between the virtual camera and the specified position point are executed, and whether to continue updating the target position point is determined based on the determination result.

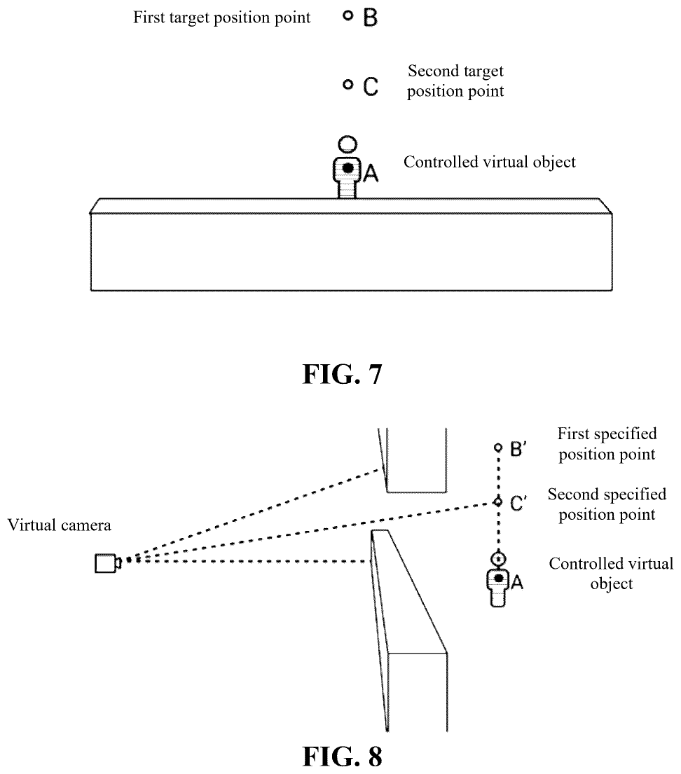

As an example, in FIG. 7, a first target position point is determined to be the point B, a corresponding specified position point B′is determined based on the point B, and an obstacle is present between the virtual camera and the specified position point B′. As shown in FIG. 8, the obstacle may be the first obstacle or the second obstacle mentioned above, or may be other obstacle. In this case, a second target position point is determined to be point C. As shown in FIG. 7, a corresponding specified position point C′ is determined based on the point C, and whether an obstacle is present between the virtual camera and the specified position point C′is determined. If no obstacle is present, the virtual camera is controlled to move based on the target position point which is the point C.

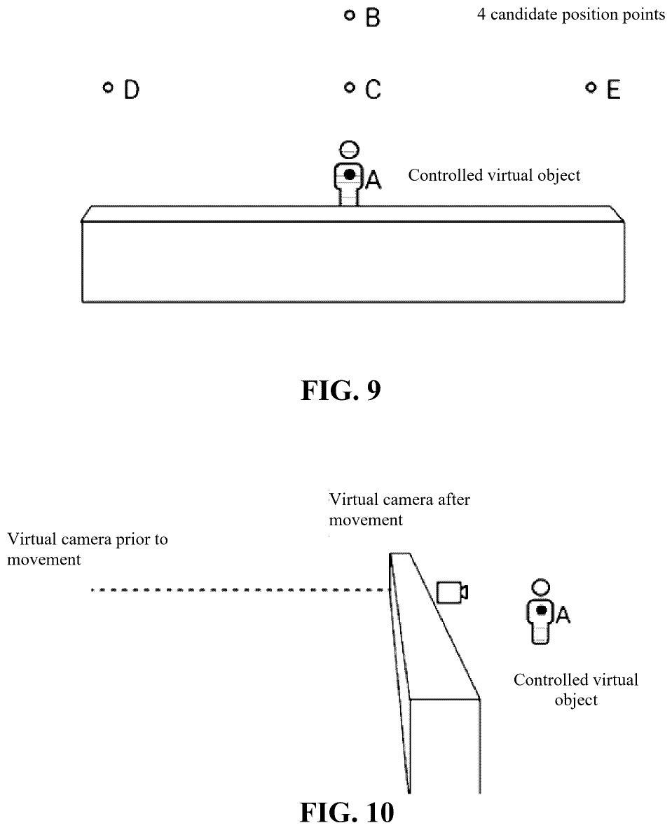

In some embodiments, the above position point selection information may record 4 candidate position points. As an example, in FIG. 9, point B, point C, point D, and point E are distributed in a central part and on both sides of the scenario picture respectively, and are selected based on the sorting rank of each candidate position point when the target position point is determined.

In the above embodiments, when the controlled virtual object is blocked, an upper part of the controlled virtual object is most likely not to be blocked, so that the lens is first pulled upward to reach the first position point. If the first position point is blocked, the lens is slightly lowered to reach the second position point, to acquire a field of view from a middle position between upper and lower blocked parts. If the central part is also blocked, it is considered to pull the lens leftward or rightward, that is, the third position point and the fourth position point mentioned above. Such sorting by priorities can avoid repeated traversals of candidate position points, and effectively reduce the system overhead.

In response to the second obstacle remaining present between the virtual camera and the specified position point when the target position point is updated to the fourth position point, the virtual camera is controlled to move to a preset position where the first obstacle is blocked, where the preset position and the controlled virtual object are located on a same side of the first obstacle.

As an example, in FIG. 10, if the target position point is selected multiple times and an obstacle remains present between the virtual camera and the specified position point, in this case, the virtual camera is directly controlled to move to the preset position of the first obstacle blocking the controlled virtual object. As shown in FIG. 10, the preset position and the controlled virtual object are located on the same side of the first obstacle, so that the controlled virtual object that is not blocked appears in the captured scenario picture.

In the above method for controlling a game picture, after the controlled virtual object is blocked by a model, a most reliable lens strategy can be taken to ensure that the player can still see a character, without awkwardly bringing the lens close to the character body, which leads to chaotic pictures, disrupts player's normal operation of the character, and even causes physiological discomfort, such as dizziness or vomiting, arising from the rapid and frequent movement of the lens, thereby improving the stability of picture changes.

In another embodiment, in response to the controlled virtual object in the first scenario picture being blocked by the first obstacle, a display region of the first obstacle blocking the controlled virtual object is determined from the first scenario picture, and the target position point is determined from a region out of the display region.

In some embodiments, it is necessary to determine a position of the second obstacle blocking the controlled virtual object from the virtual scenario, and then determine a display region of the second obstacle in the first scenario picture based on relevant parameters of the virtual camera. After a position point in the display region is mapped to the virtual scenario, the mapping point is located on the second obstacle. Therefore, it is difficult to determine the specified position point on the plane where the controlled virtual object is located based on the mapping point. On this basis, the target position point is determined from a region out of the display region of the second obstacle.

In some embodiments, after the display region of the second obstacle is determined, the target position point may be randomly determined in a region out of the display region, or the target position point may be determined based on a preset rule. For example, the target position point is selected from a central region of the first scenario picture. In some embodiments, a candidate position point may be selected from the above position point selection information, and then whether the candidate position point is located in the display region of the second obstacle may be determined. If the candidate position point is located in a region out of the display region, the candidate position point is used as the target position point; and if the candidate position point is located within the display region, a candidate position point is re-selected for determination.

In the above embodiments, the target position point is determined from a region out of the display region of the obstacle, so that the determined target position point is more accurate and appropriate.

A process of determining the mapping point of the target position point in the virtual scenario is described in the following embodiments.

To facilitate understanding, a process of generating the first scenario picture is first described.

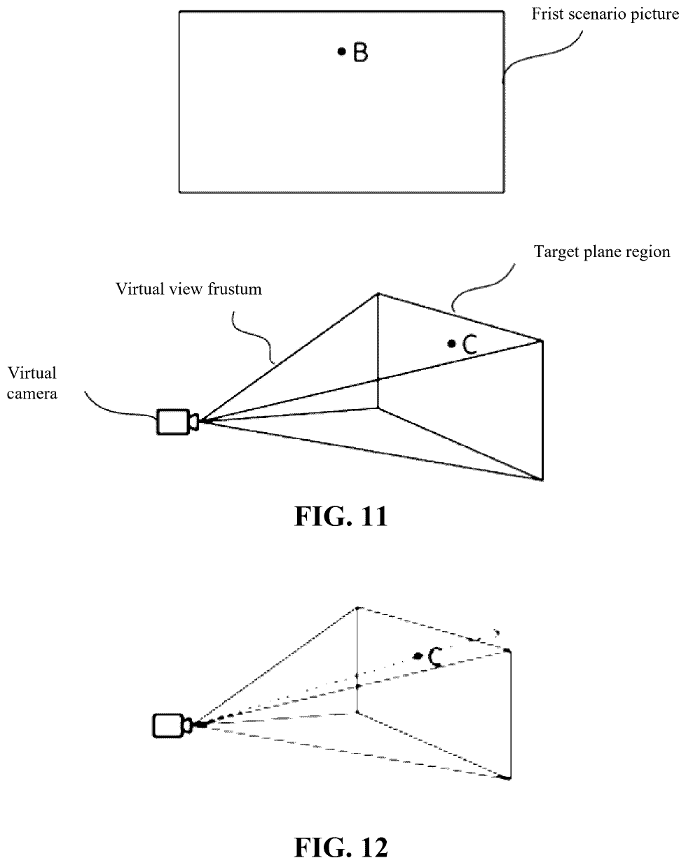

As shown in FIG. 11, a virtual camera performs photographing in a virtual scenario. The field of view of the virtual camera may be represented as a virtual view frustum. A vertex of the virtual view frustum is the virtual camera. In theory, the virtual view frustum may extend wirelessly along an orientation direction of the virtual camera, all planes in the orientation direction of the virtual camera in the virtual scenario intersect, and these planes are perpendicular to the orientation direction of the virtual camera. It is understandable that the farther the plane is from the virtual camera, the farther the depth of field is. Therefore, when a shooting depth of field of the virtual camera is determined, a captured picture of the virtual camera can be determined. The captured picture is displayed on the terminal device, thus obtaining the first scenario picture.

Considering that display screens of terminal devices have different sizes, when the first scenario picture is displayed through the captured picture, a zoom operation may be required, so that the zoomed captured picture has a same size as the display screen of the terminal device to obtain the first scenario picture.

As can be known from the above process of generating the first scenario picture, a definite mapping point can be found from the virtual space for any point in the first scenario picture.

Specifically, a target plane region corresponding to the first scenario picture in the virtual scenario is determined based on depth information of the first scenario picture; a side ratio of the first scenario picture to the target plane region is determined; and the mapping point corresponding to the target position point is determined from the target plane region based on a position of the target position point in the first scenario picture and the side ratio, where the position of the target position point in the first scenario picture is same as a position of the mapping point in the target plane region.

The above side ratio may specifically be a length ratio of the horizontal side of the first scenario picture to the horizontal side of the target plane region, or may be a length ratio of the longitudinal side of the first scenario picture to the longitudinal side of the target plane region. The side ratio may be understood as a scaling ratio of a captured picture captured by the virtual camera under the above depth information to the first scenario picture.

As an example, if the first scenario picture has a length of 2000 and a width of 1000, and the target plane region has a length of 3000 and a width of 1500, in this case, the side ratio may be expressed as 2:3; then, a coordinate of the target position point in the first scenario picture is (1000, 300). This coordinate is multiplied by the side ratio to obtain a coordinate (1500, 450) of the mapping point in the target plane region.

Further, because the target plane region has a definite three-dimensional coordinate representation range in a three-dimensional coordinate system of the virtual scenario, two-dimensional coordinates of the target plane region are converted into three-dimensional coordinates, to obtain a coordinate of the mapping point in the three-dimensional coordinate system of the virtual scenario.

The target plane region corresponding to the first scenario picture in the virtual scenario is a captured picture captured by the virtual camera under the depth information. In some embodiments, a virtual view frustum corresponding to the virtual camera is determined, where the virtual camera is located at a first vertex of the virtual view frustum; the target plane corresponding to the first scenario picture in the virtual scenario is determined based on the depth information of the first scenario picture, where the target plane is perpendicular to an orientation direction of the virtual camera, and a perpendicular distance between the target plane and the virtual camera is determined based on the depth information of the first scenario picture; and a region in the target plane that intersects with the virtual view frustum is determined as the target plane region.

Continuing to refer to FIG. 11, there are a plurality of planes along the orientation direction of the virtual camera. Each of the planes is perpendicular to the orientation direction of the virtual camera, and distances between different planes and the virtual camera are different. Therefore, a distance between the virtual camera and the target plane can be obtained based on the depth information of the first scenario picture, a target plane where the target plane region is located can be uniquely determined based on the distance, and then the region in the target plane that intersects with the virtual view frustum is determined as the target plane region.

In FIG. 12, based on mapping of the point C, a connection line between the virtual camera and the point C, as shown by the dotted line, is the virtual straight line in the above embodiments.

A specific implementation of controlling the virtual camera to move based on the mapping point continues to be described in the following embodiments. The virtual camera should move to a position where the controlled virtual object not being blocked can be photographed. Specifically, in response to the second obstacle not being present, a movement path of the virtual camera is generated based on the mapping point and a current position of the virtual camera, where the movement path has a specified shape, and a distance between any point on the movement path and the controlled virtual object is larger than or equal to the specified distance; and the virtual camera is controlled to move along the movement path from the current position.

The specified shape of the movement path may be, e.g., a straight line, a polyline, or an arc. In order to ensure that the specified distance between the virtual camera and the controlled virtual object is satisfied, when the movement path is generated, a distance between each of all or a part of points on the movement path and the controlled virtual object may be detected. If a distance between each of a part of points on the movement path and the controlled virtual object is smaller than the above specified distance, the shape and position of the path corresponding to this part of points may be adjusted.

Since the virtual camera needs to move from the current position, the current position of the virtual camera may be used as the starting point of the movement path, and the end point of the movement path may be determined based on the mapping point. In some embodiments, the mapping point may be used as the end point of the movement path, or a surrounding point of the mapping point may be used as the end point of the movement path. In some embodiments, the movement path may pass through the mapping point, and the end point of the movement path is determined based on the direction of the movement path after the mapping point. The mapping point only functions to guide the direction and the end point of the movement path; or the movement path may pass through the surrounding point of the mapping point.

In some embodiments, the virtual camera is controlled to rotate around the controlled virtual object with the controlled virtual object as a center of sphere, and during the rotation, the distance between the virtual camera and the controlled virtual object may be adjusted.

In order to further make the field of view of the scenario picture relatively stable, when the movement path is generated, a point on the movement path is jointly determined based on the distance between the virtual camera and the controlled virtual object and the distance between the mapping point and the controlled virtual object. Specifically, in response to the second obstacle not being present, an arc-shaped movement path is generated with the current position of the virtual camera as the starting point, where the distance between any point on the movement path and the controlled virtual object is determined based on a first distance value between the current position and the controlled virtual object and a second distance value between a position of the mapping point and the controlled virtual object.

As an example, if the first distance value between the current position of the virtual camera and the controlled virtual object is D1, the second distance value between the mapping point position and the controlled virtual object is D2, and D1 is larger than D2, in the generated movement path, a distance between a point on a path close to the current position of the virtual camera and the controlled virtual object is close to D1, but is slightly smaller than D1; and a distance between a point on a path close to the position of the mapping point and the controlled virtual object is close to D2, but is slightly larger than D2.

A distance between a point on the movement path and the controlled virtual object may also be implemented in other ways. For example, an average value of the above first distance value and the above second distance value is obtained, and a distance range is determined based on the average value, so that the distance between the point on the movement path and the controlled virtual object is within this distance range.

In the above embodiments, the distance between a point on the movement path and the controlled virtual object is jointly determined based on the distance between the virtual camera and the controlled virtual object and the distance between the mapping point and the controlled virtual object, so that the distance between the virtual camera during movement and the controlled virtual object is in a relatively stable state, so that the angle of view of the captured scenario picture is relatively stable, thus avoiding the problem of excessive change in the angle of view of the picture.

When the virtual camera is controlled to move along the movement path from the current position, in one embodiment, the virtual camera is controlled to move along the movement path from the current position until reaching the end point of the movement path, where the end point is determined based on the mapping point. In some embodiments, the end point of the movement path is the mapping point, and the virtual camera can move along the movement path until reaching the mapping point. In this case, the virtual camera is at the mapping point, and the shooting angle can be adjusted, so that the controlled virtual object appears in the scenario picture. For some special obstacles or special scenarios, when photographing the controlled virtual object at the mapping point, the virtual camera may still fail to photograph the controlled virtual object, or the controlled virtual object is still blocked by an obstacle. In this case, the end point of the movement path may be redetermined in the vicinity of the mapping point until the virtual camera can photograph the controlled virtual object at the end point position.

In addition, the virtual camera can move to the end point of the movement path at a very large velocity. In this case, the player generally sees the effect of scenario picture switching from the scenario picture. The virtual camera may also move to the end point of the movement path at a relatively slow velocity. In this case, the picture contents of the scenario picture gradually change, and the player sees changes of the scenario picture with a long-shot lens effect from the scenario picture.

In some embodiments, the virtual camera is controlled to move along the movement path from the current position; during the movement of the virtual camera, the orientation of the virtual camera is adjusted based on the position of the controlled virtual object in the virtual scenario; and when the controlled virtual object in the second scenario picture captured by the virtual camera is not blocked, the virtual camera is controlled to stop moving.

Specifically, a three-dimensional coordinate of the controlled virtual object in the three-dimensional space of the virtual scenario may be pre-acquired. When the virtual camera moves along the movement path, the shooting angle and shooting posture of the virtual camera are adjusted in real time based on the three-dimensional coordinate of the controlled virtual object; it is also understandable that the virtual camera always performs photographing towards the position of the controlled virtual object during the movement; and when the controlled virtual object that is not blocked appears in the second scenario picture captured by the virtual camera, the virtual camera is controlled to stop moving. In this case, the virtual camera may not have reached the end point of the movement path, or may have reached the end point of the movement path.

If the controlled virtual object that is not blocked does not appear in the second scenario picture after the virtual camera reaches the end point of the movement path, in this case, a movement path segment may continue to be generated towards the extension direction of the movement path, and the virtual camera is controlled to move along the newly generated movement path until the controlled virtual object that is not blocked appears in the second scenario picture.

In the above embodiments, when the controlled virtual object appears in the scenario picture, the virtual camera stops moving and performs photographing at that position, thereby minimizing changes of the angle of view of the scenario picture, and improving the stability of the visual effects of the scenario picture.

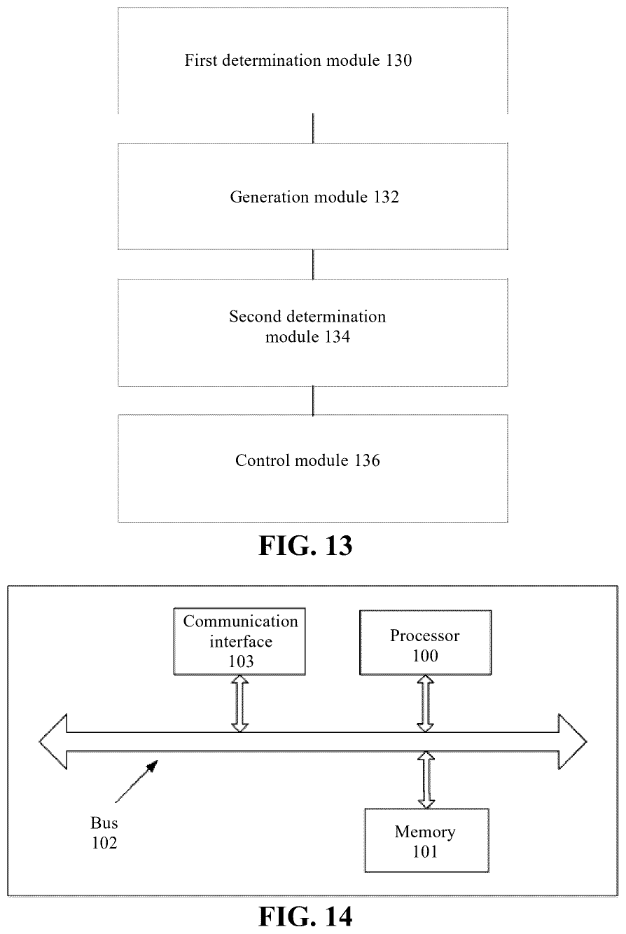

Corresponding to the above method embodiments, referring to a schematic structural diagram of an apparatus for controlling a game picture shown in FIG. 13, a graphical user interface is provided through a terminal device; and the graphical user interface displays: a first scenario picture captured in a virtual scenario by a virtual camera in a game. The apparatus includes:
a first determination module 130 configured to determine, in response to a controlled virtual object in the first scenario picture being blocked by a first obstacle, a target position point from the first scenario picture, where the controlled virtual object is controlled through the terminal device;
a generation module 132 configured to generate a virtual straight line based on a mapping point of the target position point in the virtual scenario and a position of the virtual camera in the virtual scenario;
a second determination module 134 configured to determine an intersection point of the virtual straight line and a plane where the controlled virtual object is located, and determine the intersection point as a specified position point on the plane where the controlled virtual object is located, where a connection line between the position of the virtual camera in the virtual scenario and a position of the controlled virtual object forms a preset angle with the plane where the controlled virtual object is located; and
a control module 136 configured to determine whether a second obstacle is present between the virtual camera and the specified position point; and control, in response to the second obstacle not being present, the virtual camera to move based on the mapping point, so that the controlled virtual object in a second scenario picture captured by the virtual camera after movement is not blocked, where the second obstacle comprises the first obstacle or an obstacle other than the first obstacle.

The above apparatus for controlling a game picture determines, in response to a controlled virtual object in a first scenario picture being blocked by a first obstacle, a target position point from the first scenario picture, where the controlled virtual object is controlled through a terminal device; generates a virtual straight line based on a mapping point of the target position point in a virtual scenario and a position of the virtual camera in the virtual scenario; determines an intersection point of the virtual straight line and a plane where the controlled virtual object is located, and determines the intersection point as a specified position point on the plane where the controlled virtual object is located, where a connection line between the position of the virtual camera in the virtual scenario and a position of the controlled virtual object forms a preset angle with the plane where the controlled virtual object is located; determines whether a second obstacle is present between the virtual camera and the specified position point; and controls, in response to the second obstacle not being present, the virtual camera to move based on the mapping point, so that the controlled virtual object in a second scenario picture captured by the virtual camera after movement is not blocked, where the second obstacle comprises the first obstacle or an obstacle other than the first obstacle.

In some embodiments, a target position point is first determined from a scenario picture, a mapping point of the target position point located in a virtual scenario is obtained, then a specified position point is determined on a plane where a controlled virtual object is located based on the mapping point, and when no obstacle is present between a virtual camera and the specified position point, the virtual camera is controlled to move based on the mapping point, so that this method can prevent the controlled virtual object in the scenario captured by the virtual camera from being blocked; and when the controlled virtual object is blocked, a taking lens is adjusted relatively smoothly, so that players not only can continue observing the controlled virtual object, but also can observe global information of the scenario, thereby improving their game experience, improving stability of a game picture displayed on a terminal device, reducing execution duration of the terminal device, and saving power consumption of the terminal device.

The above first determination module is further configured to determine, in response to the controlled virtual object in the first scenario picture being blocked by the first obstacle, the target position point from the first scenario picture based on preset position point selection information, where the position point selection information records position information of at least one candidate position point in the first scenario picture.

The above candidate position point includes: a first position point located above the controlled virtual object, a second position point located between the controlled virtual object and the first position point, a third position point located on a left side of the controlled virtual object, and a fourth position point located on a right side of the controlled virtual object; the first position point, the second position point, the third position point, and the fourth position point are arranged from highest to lowest in terms of priorities of being determined as the target position point; and the above first determination module is further configured to determine, in response to the controlled virtual object in the first scenario picture being blocked by the first obstacle, the first position point with a highest priority as the target position point.

The above apparatus further includes an updating module configured to: use, in response to the second obstacle being present between the virtual camera and the specified position point, a next position point of the target position point as an updated target position point based on the priorities; and continue to execute the step of generating the virtual straight line based on the mapping point of the target position point in the virtual scenario and the position of the virtual camera in the virtual scenario.

The above apparatus further includes a movement control module configured to: control, in response to the second obstacle remaining present between the virtual camera and the specified position point when the target position point is updated to the fourth position point, the virtual camera to move to a preset position where the first obstacle is blocked, where the preset position and the controlled virtual object are located on a same side of the first obstacle.

The above first determination module is further configured to: determine, in response to the controlled virtual object in the first scenario picture being blocked by the first obstacle, a display region blocking the first obstacle from the first scenario picture, and determine the target position point from a region out of the display region.

The above apparatus further includes a mapping point generation module configured to: determine a target plane region corresponding to the first scenario picture in the virtual scenario based on depth information of the first scenario picture; determine a side ratio of the first scenario picture to the target plane region; and determine the mapping point corresponding to the target position point from the target plane region based on a position of the target position point in the first scenario picture and the side ratio, where the position of the target position point in the first scenario picture is same as a position of the mapping point in the target plane region.

The above mapping point generation module is further configured to: determine a visual view frustum corresponding to the virtual camera, where the virtual camera is located at a first vertex of the virtual view frustum; determine a target plane corresponding to the first scenario picture in the virtual scenario based on the depth information of the first scenario picture, where the target plane is perpendicular to an orientation direction of the virtual camera, and a perpendicular distance between the target plane and the virtual camera is determined based on the depth information of the first scenario picture; and determine a region in the target plane that intersects with the virtual view frustum as the target plane region.

The above control module is further configured to: generate, in response to the second obstacle not being present, a movement path of the virtual camera based on the mapping point and a current position of the virtual camera, where the movement path has a specified shape, and a distance between any point on the movement path and the controlled virtual object is larger than or equal to the specified distance; and control the virtual camera to move along the movement path from the current position.

The above control module is further configured to: generate, in response to the second obstacle not being present, an arc-shaped movement path with the current position of the virtual camera as a starting point, where the distance between any point on the movement path and the controlled virtual object is determined based on a first distance value between the current position and the controlled virtual object and a second distance value between a position of the mapping point and the controlled virtual object.

The above control module is further configured to: control the virtual camera to move along the movement path from the current position until reaching an end point of the movement path, where the end point is determined based on the mapping point.

The above control module is further configured to: control the virtual camera to move along the movement path from the current position; adjust an orientation of the virtual camera based on the position of the controlled virtual object in the virtual scenario during the movement of the virtual camera; and control the virtual camera to stop moving when the controlled virtual object in the second scenario picture captured by the virtual camera is not blocked.

This embodiment further provides an electronic device, comprising a processor and a memory, where the memory stores machine-executable instructions that can be executed by the processor, and the processor executes the machine-executable instructions to implement the above method for controlling a game picture. The electronic device may be a server, or may be a touch terminal device.

Referring to FIG. 14, the electronic device comprises a processor 100 and a memory 101, where the memory 101 stores machine-executable instructions that can be executed by the processor 100, and the processor 100 executes the machine-executable instructions to implement the above method for controlling a game picture.

Further, the electronic device shown in FIG. 14 further comprises a bus 102 and a communication interface 103, where the processor 100, the communication interface 103, and the memory 101 are connected through the bus 102.

The memory 101 may include a high-speed random access memory (RAM), and may further include a non-volatile memory, e.g., at least one disk memory. A communication connection between the system network element and at least one other network element may be implemented through at least one communication interface 103 (either wired or wireless) using the Internet, a wide area network, a local network, a metropolitan area network, or the like. The bus 102 may be an ISA bus, a PCI bus, an EISA bus, or the like. The bus may be classified into an address bus, a data bus, a control bus, and the like. For ease of presentation, only one bidirectional arrow is used in FIG. 14, but it does not mean that there is only one bus or one type of bus.

The processor 100 may be an integrated circuit chip with a signal processing capability. In some embodiments, steps of the above method may be completed by an integrated logic circuit of hardware in the processor 100 or instructions in the form of software. The above processor 100 may be a general-purpose processor, including a Central Processing Unit (abbreviated as CPU), and a Network Processor (abbreviated as NP), etc., or may be a digital signal processor (abbreviated as DSP), an Application Specific Integrated Circuit (abbreviated as ASIC), a Field-Programmable Gate Array (abbreviated as FPGA) or other programmable logic devices, a discrete gate or transistor logic device, or a discrete hardware component, and can implement or execute the methods, steps, and logical block diagrams disclosed in the embodiments of the present disclosure. The general-purpose processor may be a microprocessor or the processor may also be any conventional processor or the like. The steps of the method disclosed in the embodiments of the present disclosure may be directly embodied as being executed and completed by a hardware decoding processor, or being executed and completed by a combination of hardware and software modules in the decoding processor. The software module may be located in a mature storage medium in the art, such as a random access memory, a flash memory, a read-only memory, a programmable read-only memory or an electrically erasable programmable memory, or a register. The storage medium is located in the memory 101. The processor 100 reads information from the memory 101, and completes the steps of the method in the above embodiments in combination with its hardware.

The processor in the above electronic device can implement the following operations in the above method for controlling a game picture by executing the machine-executable instructions:
a graphical user interface displaying: a first scenario picture captured in a virtual scenario by a virtual camera in a game; determining, in response to a controlled virtual object in the first scenario picture being blocked by a first obstacle, a target position point from the first scenario picture, where the controlled virtual object is controlled through the terminal device; generating a virtual straight line based on a mapping point of the target position point in the virtual scenario and a position of the virtual camera in the virtual scenario; determining an intersection point of the virtual straight line and a plane where the controlled virtual object is located, and determining the intersection point as a specified position point on the plane where the controlled virtual object is located, where a connection line between the position of the virtual camera in the virtual scenario and a position of the controlled virtual object forms a preset angle with the plane where the controlled virtual object is located; determining whether a second obstacle is present between the virtual camera and the specified position point; and controlling, in response to the second obstacle not being present, the virtual camera to move based on the mapping point, so that the controlled virtual object in a second scenario picture captured by the virtual camera after movement is not blocked, where the second obstacle comprises the first obstacle or an obstacle other than the first obstacle.

In some embodiments, a target position point is first determined from a scenario picture, a mapping point of the target position point located in a virtual scenario is obtained, then a specified position point is determined on a plane where a controlled virtual object is located based on the mapping point, and when no obstacle is present between a virtual camera and the specified position point, the virtual camera is controlled to move based on the mapping point, so that this method can prevent the controlled virtual object in the scenario captured by the virtual camera from being blocked; and when the controlled virtual object is blocked, a taking lens is adjusted relatively smoothly, so that players not only can continue observing the controlled virtual object, but also can observe global information of the scenario, thereby improving their game experience, improving stability of a game picture displayed on a terminal device, reducing execution duration of the terminal device, and saving power consumption of the terminal device.

In response to the controlled virtual object in the first scenario picture being blocked by the first obstacle, the target position point is determined from the first scenario picture based on preset position point selection information, where the position point selection information records position information of at least one candidate position point in the first scenario picture.

In the above embodiments, the target position point is determined based on the position point selection information, which is convenient and simple with a small calculation amount.

The above candidate position point includes: a first position point located above the controlled virtual object, a second position point located between the controlled virtual object and the first position point, a third position point located on a left side of the controlled virtual object, and a fourth position point located on a right side of the controlled virtual object; the first position point, the second position point, the third position point, and the fourth position point are arranged from highest to lowest in terms of priorities of being determined as the target position point; and, in response to the controlled virtual object in the first scenario picture being blocked by the first obstacle, the first position point with a highest priority is determined as the target position point.

In response to the second obstacle being present between the virtual camera and the specified position point, a next position point of the target position point is used as an updated target position point based on the priorities; and the step of generating the virtual straight line based on the mapping point of the target position point in the virtual scenario and the position of the virtual camera in the virtual scenario continues to be executed.

In the above embodiments, when the controlled virtual object is blocked, an upper part of the controlled virtual object is most likely not to be blocked, so that the lens is first pulled upward to reach the first position point. If the first position point is blocked, the lens is slightly lowered to reach the second position point, to acquire a field of view from a middle position between upper and lower blocked parts. If the central part is also blocked, it is considered to pull the lens leftward or rightward, that is, the third position point and the fourth position point mentioned above. Such priority sorting can avoid repeated traversals of candidate position points, and effectively reduce the system overhead.

In response to the second obstacle remaining present between the virtual camera and the specified position point when the target position point is updated to the fourth position point, the virtual camera is controlled to move to a preset position where the first obstacle is blocked, where the preset position and the controlled virtual object are located on a same side of the first obstacle.

In response to the controlled virtual object in the first scenario picture being blocked by the first obstacle, a display region blocking the first obstacle is determined from the first scenario picture, and the target position point is determined from a region out of the display region.

In the above embodiments, the target position point is determined from a region out of the display region of the obstacle, so that the determined target position point is more accurate and appropriate.

A target plane region corresponding to the first scenario picture in the virtual scenario is determined based on depth information of the first scenario picture; a side ratio of the first scenario picture to the target plane region is determined; and the mapping point corresponding to the target position point is determined from the target plane region based on a position of the target position point in the first scenario picture and the side ratio, where the position of the target position point in the first scenario picture is same as a position of the mapping point in the target plane region.

A virtual view frustum corresponding to the virtual camera is determined, where the virtual camera is located at a first vertex of the virtual view frustum; the target plane corresponding to the first scenario picture in the virtual scenario is determined based on the depth information of the first scenario picture, where the target plane is perpendicular to an orientation direction of the virtual camera, and a perpendicular distance between the target plane and the virtual camera is determined based on the depth information of the first scenario picture; and a region in the target plane that intersects with the virtual view frustum is determined as the target plane region.

In response to the second obstacle not being present, a movement path of the virtual camera is generated based on the mapping point and a current position of the virtual camera, where the movement path has a specified shape, and a distance between any point on the movement path and the controlled virtual object is larger than or equal to the specified distance; and the virtual camera is controlled to move along the movement path from the current position.

In response to the second obstacle not being present, an arc-shaped movement path is generated with the current position of the virtual camera as the starting point, where the distance between any point on the movement path and the controlled virtual object is determined based on a first distance value between the current position and the controlled virtual object and a second distance value between a position of the mapping point and the controlled virtual object.

In the above embodiments, the distance between a point on the movement path and the controlled virtual object is jointly determined based on the distance between the virtual camera and the controlled virtual object and the distance between the mapping point and the controlled virtual object, so that the distance between the virtual camera during movement and the controlled virtual object is in a relatively stable state, so that the angle of view of the captured scenario picture is relatively stable, thus avoiding the problem of excessive change in the angle of view of the picture.

The virtual camera is controlled to move along the movement path from the current position until reaching an end point of the movement path, where the end point is determined based on the mapping point.

The virtual camera is controlled to move along the movement path from the current position; during the movement of the virtual camera, the orientation of the virtual camera is adjusted based on the position of the controlled virtual object in the virtual scenario; and when the controlled virtual object in the second scenario picture captured by the virtual camera is not blocked, the virtual camera is controlled to stop moving.

In the above embodiments, when the controlled virtual object appears in the scenario picture, the virtual camera stops moving and performs photographing at that position, thereby minimizing changes of the angle of view of the scenario picture, and improving the stability of the visual effects of the scenario picture.

In the above embodiments, after the controlled virtual object is blocked by a model, a most reliable lens measure can be taken to ensure that the player can still see a character, without rudely bringing the lens close to the character body, which causes the picture to be confused, causes failure to operate the character normally by the player, and even causes physiological discomfort, such as dizziness or vomiting, arising from the rapid and frequent movement of the lens, thereby improving the stability of picture changes.

This embodiment further provides a machine-readable storage medium, storing machine-executable instructions, where the machine-executable instructions, when invoked and executed by a processor, promotes the processor to implement the above method for controlling a game picture.

The machine-executable instructions stored in the above machine-readable storage medium can implement the following operations in the above method for controlling a game picture by executing the machine-executable instructions:
a graphical user interface displaying: a first scenario picture captured in a virtual scenario by a virtual camera in a game; determining, in response to a controlled virtual object in the first scenario picture being blocked by a first obstacle, a target position point from the first scenario picture, where the controlled virtual object is controlled through the terminal device; generating a virtual straight line based on a mapping point of the target position point in the virtual scenario and a position of the virtual camera in the virtual scenario; determining an intersection point of the virtual straight line and a plane where the controlled virtual object is located, and determining the intersection point as a specified position point on the plane where the controlled virtual object is located, where a connection line between the position of the virtual camera in the virtual scenario and a position of the controlled virtual object forms a preset angle with the plane where the controlled virtual object is located; determining whether a second obstacle is present between the virtual camera and the specified position point; and controlling, in response to the second obstacle not being present, the virtual camera to move based on the mapping point, so that the controlled virtual object in a second scenario picture captured by the virtual camera after movement is not blocked, where the second obstacle comprises the first obstacle or an obstacle other than the first obstacle.

In some embodiments, a target position point is first determined from a scenario picture, a mapping point of the target position point located in a virtual scenario is obtained, then a specified position point is determined on a plane where a controlled virtual object is located based on the mapping point, and when no obstacle is present between a virtual camera and the specified position point, the virtual camera is controlled to move based on the mapping point, so that this method can prevent the controlled virtual object in the scenario captured by the virtual camera from being blocked; and when the controlled virtual object is blocked, a taking lens is adjusted relatively smoothly, so that players not only can continue observing the controlled virtual object, but also can observe global information of the scenario, thereby improving their game experience, improving stability of a game picture displayed on a terminal device, reducing execution duration of the terminal device, and saving power consumption of the terminal device.

In response to the controlled virtual object in the first scenario picture being blocked by the first obstacle, the target position point is determined from the first scenario picture based on preset position point selection information, where the position point selection information records position information of at least one candidate position point in the first scenario picture.

In the above embodiments, the target position point is determined based on the position point selection information, which is convenient and simple with a small calculation amount.

The above candidate position point includes: a first position point located above the controlled virtual object, a second position point located between the controlled virtual object and the first position point, a third position point located on a left side of the controlled virtual object, and a fourth position point located on a right side of the controlled virtual object; the first position point, the second position point, the third position point, and the fourth position point are arranged from highest to lowest in terms of priorities of being determined as the target position point; and, in response to the controlled virtual object in the first scenario picture being blocked by the first obstacle, the first position point with a highest priority is determined as the target position point.

In response to the second obstacle being present between the virtual camera and the specified position point, a next position point of the target position point is used as an updated target position point based on the priorities; and the step of generating the virtual straight line based on the mapping point of the target position point in the virtual scenario and the position of the virtual camera in the virtual scenario continues to be executed.

In the above embodiments, when the controlled virtual object is blocked, an upper part of the controlled virtual object is most likely not to be blocked, so that the lens is first pulled upward to reach the first position point. If the first position point is blocked, the lens is slightly lowered to reach the second position point, to acquire a field of view from a middle position between upper and lower blocked parts. If the central part is also blocked, it is considered to pull the lens leftward or rightward, that is, the third position point and the fourth position point mentioned above. Such priority sorting can avoid repeated traversals of candidate position points, and effectively reduce the system overhead.

In response to the second obstacle remaining present between the virtual camera and the specified position point when the target position point is updated to the fourth position point, the virtual camera is controlled to move to a preset position where the first obstacle is blocked, where the preset position and the controlled virtual object are located on a same side of the first obstacle.

In response to the controlled virtual object in the first scenario picture being blocked by the first obstacle, a display region blocking the first obstacle is determined from the first scenario picture, and the target position point is determined from a region out of the display region.

In the above embodiments, the target position point is determined from a region out of the display region of the obstacle, so that the determined target position point is more accurate and appropriate.

A target plane region corresponding to the first scenario picture in the virtual scenario is determined based on depth information of the first scenario picture; a side ratio of the first scenario picture to the target plane region is determined; and the mapping point corresponding to the target position point is determined from the target plane region based on a position of the target position point in the first scenario picture and the side ratio, where the position of the target position point in the first scenario picture is same as a position of the mapping point in the target plane region.

A virtual view frustum corresponding to the virtual camera is determined, where the virtual camera is located at a first vertex of the virtual view frustum; the target plane corresponding to the first scenario picture in the virtual scenario is determined based on the depth information of the first scenario picture, where the target plane is perpendicular to an orientation direction of the virtual camera, and a perpendicular distance between the target plane and the virtual camera is determined based on the depth information of the first scenario picture; and a region in the target plane that intersects with the virtual view frustum is determined as the target plane region.

In response to the second obstacle not being present, a movement path of the virtual camera is generated based on the mapping point and a current position of the virtual camera, where the movement path has a specified shape, and a distance between any point on the movement path and the controlled virtual object is larger than or equal to the specified distance; and the virtual camera is controlled to move along the movement path from the current position.

In response to the second obstacle not being present, an arc-shaped movement path is generated with the current position of the virtual camera as the starting point, where the distance between any point on the movement path and the controlled virtual object is determined based on a first distance value between the current position and the controlled virtual object and a second distance value between a position of the mapping point and the controlled virtual object.

In the above embodiments, the distance between a point on the movement path and the controlled virtual object is jointly determined based on the distance between the virtual camera and the controlled virtual object and the distance between the mapping point and the controlled virtual object, so that the distance between the virtual camera during movement and the controlled virtual object is in a relatively stable state, so that the angle of view of the captured scenario picture is relatively stable, thus avoiding the problem of excessive change in the angle of view of the picture.

The virtual camera is controlled to move along the movement path from the current position until reaching an end point of the movement path, where the end point is determined based on the mapping point.

The virtual camera is controlled to move along the movement path from the current position; during the movement of the virtual camera, the orientation of the virtual camera is adjusted based on the position of the controlled virtual object in the virtual scenario; and when the controlled virtual object in the second scenario picture captured by the virtual camera is not blocked, the virtual camera is controlled to stop moving.

In the above embodiments, when the controlled virtual object appears in the scenario picture, the virtual camera stops moving and performs photographing at that position, thereby minimizing changes of the angle of view of the scenario picture, and improving the stability of the visual effects of the scenario picture.

In the above embodiments, after the controlled virtual object is blocked by a model, a most reliable lens measure can be taken to ensure that the player can still see a character, without rudely bringing the lens close to the character body, which causes the picture to be confused, causes failure to operate the character normally by the player, and even causes physiological discomfort, such as dizziness or vomiting, arising from the rapid and frequent movement of the lens, thereby improving the stability of picture changes.

The method for controlling a game picture, the apparatus for controlling a game picture, and a computer program product of the electronic device provided in the embodiments of the present disclosure include a computer-readable storage medium storing a program code. The instructions included in the program code can be used to execute the method in the above method embodiments. The method embodiments may be referred to for specific implementations, which will not be repeated here.

Those skilled in the art can clearly understand that, for convenience and simplicity of description, corresponding processes in the above method embodiments may be referred to for specific operating process of the above described system and apparatus, which will not be repeated here.

In addition, in the description of the embodiments of the present disclosure, unless otherwise explicitly stipulated and defined, the terms “mounting,” “joint,” and “connection” should be understood in a broad sense, such as a fixed connection, a detachable connection, an integrated connection; a mechanical connection, an electrical connection; a direct connection, an indirect connection through an intermediate medium, or an internal connection of two elements. For those of ordinary skills in the art, the specific meanings of the above terms in the present disclosure may be understood based on specific circumstances.

The function may be stored in a computer-readable storage medium when it is implemented in the form of a software functional unit and is sold or used as a separate product. Based on such understanding, the technical solutions of the present application essentially, or a part of the technical solutions that contribute to the relevant art, or the part of the technical solutions may be embodied in the form of a software product which is stored in a storage medium and includes some instructions for causing a computer device (which may be, e.g., a personal computer, a server, or a network device) to execute all or some of the steps of the method in the embodiments of the present disclosure. The above storage medium includes: various mediums that can store a program code, such as a U disk, a mobile hard disk, a read-only memory (ROM), a random access memory (RAM), a magnetic disk, or an optical disk.

In the description of the present disclosure, it should be noted that the directions or position relationships indicated by the terms, such as “center,” “above,” “below,” “left,” “right,” “vertical,” “horizontal,” “inner,” and “outer,” are based on the directions or position relationships shown in the drawings, are only provided to facilitate describing the present disclosure and simplifying the description, rather than indicating or implying that the apparatus or element referred to must have a particular direction, or be constructed and operated in a particular direction, and therefore cannot be construed as limiting the present disclosure. In addition, the terms “first”, “second” and “third” are used for descriptive purposes only, and cannot be construed as indicating or implying relative importance.

Finally, it should be noted that: the above embodiments are merely specific embodiments of the present disclosure used to illustrate the technical solutions of the present disclosure, instead of imposing any limitation on the present disclosure. The scope of protection of the present disclosure is not limited to the above embodiments. Although the present disclosure has been described in detail with reference to the above embodiments, those skilled in the art should understand that: any person skilled in the art may still modify or easily conceive of altering the technical solutions disclosed in the above embodiments or equivalently replace a part of the technical features thereof within the technical scope disclosed in the present disclosure. These modifications, alterations, or replacements are not intended to make the essence of corresponding technical solutions depart from the spirit and scope of the technical solutions of the embodiments of the present disclosure, but are encompassed within the scope of protection of the present disclosure. Therefore, the scope of protection of the present disclosure should be determined by the scope of protection of the claims.

1. A method for controlling a game picture, the method comprising:
in response to detecting that a controlled virtual object in a first scenario picture is blocked by a first obstacle, determining a target position point in the first scenario picture, wherein the controlled virtual object is controlled through a terminal device, and the first scenario picture is captured in a virtual scenario by a virtual camera in a game and displayed by a graphical user interface of the terminal device;
generating a virtual straight line based on a mapping point of the target position point in the virtual scenario and a position of the virtual camera in the virtual scenario;
determining an intersection point of the virtual straight line and a plane that comprises the controlled virtual object;
determining the intersection point as a specified position point on the plane that comprises the controlled virtual object, wherein a connection line between the position of the virtual camera in the virtual scenario and a position of the controlled virtual object forms a preset angle with the plane that comprises the controlled virtual object;
determining whether a second obstacle is present between the virtual camera and the specified position point; and
controlling, in response to detecting that the second obstacle is not present, the virtual camera to move based on the mapping point, wherein the controlled virtual object in a second scenario picture captured by the virtual camera after movement is not blocked, and the second obstacle comprises the first obstacle or an obstacle other than the first obstacle.

2. The method according to claim 1, wherein in response to detecting that the controlled virtual object in the first scenario picture is blocked by the first obstacle, determining the target position point in the first scenario picture comprises:
in response to detecting that the controlled virtual object in the first scenario picture is blocked by the first obstacle, determining the target position point in the first scenario picture based on preset position point selection information, wherein the position point selection information comprises position information of at least one candidate position point in the first scenario picture.

3. The method according to claim 2, wherein the candidate position point comprises: a first position point located above the controlled virtual object, a second position point located between the controlled virtual object and the first position point, a third position point located on a left side of the controlled virtual object, and a fourth position point located on a right side of the controlled virtual object; and
the first position point, the second position point, the third position point, and the fourth position point are arranged in a descending order, from highest to lowest, in terms of priorities of being determined as the target position point; and
in response to detecting that the controlled virtual object in the first scenario picture is blocked by the first obstacle, determining the target position point in the first scenario picture based on the preset position point selection information comprises:
in response to detecting that the controlled virtual object in the first scenario picture is blocked by the first obstacle, determining a position point with a highest priority as the target position point.

4. The method according to claim 3, wherein the method further comprises:
using, in response to the second obstacle being present between the virtual camera and the specified position point, based on the descending order in terms of priorities, a position point with a second highest priority as an updated target position point; and
generating the virtual straight line based on the mapping point of the updated target position point in the virtual scenario and the position of the virtual camera in the virtual scenario.

5. The method according to claim 3, wherein the method further comprises:
controlling, in response to the second obstacle remaining present between the virtual camera and the specified position point when the target position point is updated to the fourth position point, the virtual camera to move to a preset position that blocks the first obstacle, wherein the preset position and the controlled virtual object are located on a same side of the first obstacle.

6. The method according to claim 1, wherein in response to detecting that the controlled virtual object in the first scenario picture is blocked by the first obstacle, determining the target position point from the first scenario picture comprises:
in response to detecting that the controlled virtual object in the first scenario picture is blocked by the first obstacle, determining a display region blocking the first obstacle in the first scenario picture; and
determining the target position point in a region out of the display region.

7. The method according to claim 1, wherein before generating the virtual straight line based on the mapping point of the target position point in the virtual scenario and the position of the virtual camera in the virtual scenario, the method further comprises:
determining a target plane region corresponding to the first scenario picture in the virtual scenario based on depth information of the first scenario picture;
determining a side ratio of the first scenario picture to the target plane region; and
determining the mapping point corresponding to the target position point from the target plane region based on a position of the target position point in the first scenario picture and the side ratio, wherein the position of the target position point in the first scenario picture is same as a position of the mapping point in the target plane region.

8. The method according to claim 7, wherein determining the target plane region corresponding to the first scenario picture in the virtual scenario based on the depth information of the first scenario picture comprises:
determining a virtual view frustum corresponding to the virtual camera, wherein the virtual camera is located at a first vertex of the virtual view frustum;
determining a target plane corresponding to the first scenario picture in the virtual scenario based on the depth information of the first scenario picture, wherein the target plane is perpendicular to an orientation direction of the virtual camera, and a perpendicular distance between the target plane and the virtual camera is determined based on the depth information of the first scenario picture; and
determining a region in the target plane that intersects with the virtual view frustum as the target plane region.

9. The method according to claim 1, wherein controlling, in response to detecting that the second obstacle is not present, the virtual camera to move based on the mapping point comprises:
generating, in response to detecting that the second obstacle is not present, a movement path of the virtual camera based on the mapping point and a current position of the virtual camera, wherein the movement path has a specified shape, and a distance between any point on the movement path and the controlled virtual object is larger than or equal to a specified distance between the virtual camera and the controlled virtual object; and
controlling the virtual camera to move along the movement path from the current position.

10. The method according to claim 9, wherein generating, in response to detecting that the second obstacle is not present, the movement path of the virtual camera based on the mapping point and the current position of the virtual camera comprises:
generating, in response to detecting that the second obstacle is not present, an arc-shaped movement path with the current position of the virtual camera as a starting point,
wherein the distance between any point on the movement path and the controlled virtual object is determined based on a first distance value between the current position and the controlled virtual object and a second distance value between a position of the mapping point and the controlled virtual object.

11. The method according to claim 9, wherein controlling the virtual camera to move along the movement path from the current position comprises:
controlling the virtual camera to move along the movement path from the current position until reaching an end point of the movement path, wherein the end point is determined based on the mapping point.

12. The method according to claim 9, wherein controlling the virtual camera to move along the movement path from the current position comprises:
controlling the virtual camera to move along the movement path from the current position;
adjusting an orientation of the virtual camera based on the position of the controlled virtual object in the virtual scenario during the movement of the virtual camera; and
controlling the virtual camera to stop moving when the controlled virtual object in the second scenario picture captured by the virtual camera is not blocked.

13. (canceled)

14. A system, comprising:
one or more memories collectively containing one or more programs; and
one or more processors, wherein the one or more processors are configured to, individually or collectively, perform an operation comprising:
in response to detecting that a controlled virtual object in a first scenario picture is blocked by a first obstacle, determining a target position point in the first scenario picture, wherein the controlled virtual object is controlled through a terminal device, and the first scenario picture is captured in a virtual scenario by a virtual camera in a game and displayed by a graphical user interface of the terminal device;
generating a virtual straight line based on a mapping point of the target position point in the virtual scenario and a position of the virtual camera in the virtual scenario;
determining an intersection point of the virtual straight line and a plane that comprises the controlled virtual object:
determining the intersection point as a specified position point on the plane that comprises the controlled virtual object, wherein a connection line between the position of the virtual camera in the virtual scenario and a position of the controlled virtual object forms a preset angle with the plane that comprises the controlled virtual object;
determining whether a second obstacle is present between the virtual camera and the specified position point; and
controlling, in response to detecting that the second obstacle is not present, the virtual camera to move based on the mapping point, wherein the controlled virtual object in a second scenario picture captured by the virtual camera after movement is not blocked, and the second obstacle comprises the first obstacle or an obstacle other than the first obstacle.

15. One or more non-transitory computer-readable storage media containing, in any combination, computer program code that, when executable by a computer system, perform an operation comprising:
determining, in response to detecting that a controlled virtual object in a first scenario picture is blocked by a first obstacle, determining a target position point in the first scenario picture, wherein the controlled virtual object is controlled through a terminal device, and the first scenario picture is captured in a virtual scenario by a virtual camera in a game and displayed by a graphical user interface of the terminal device;
generating a virtual straight line based on a mapping point of the target position point in the virtual scenario and a position of the virtual camera in the virtual scenario;
determining an intersection point of the virtual straight line and a plane that comprises the controlled virtual object;
determining the intersection point as a specified position point on the plane that comprises the controlled virtual object, wherein a connection line between the position of the virtual camera in the virtual scenario and a position of the controlled virtual object forms a preset angle with the plane that comprises the controlled virtual object;
determining whether a second obstacle is present between the virtual camera and the specified position point; and
controlling, in response to detecting that the second obstacle is not present the virtual camera to move based on the mapping point, wherein the controlled virtual object in a second scenario picture captured by the virtual camera after movement is not blocked, and the second obstacle comprises the first obstacle or an obstacle other than the first obstacle.

16. The system according to claim 14, wherein, in response to detecting that the controlled virtual object in the first scenario picture is blocked by the first obstacle, determining the target position point from the first scenario picture comprises:
in response to detecting that the controlled virtual object in the first scenario picture is blocked by the first obstacle, determining the target position point in the first scenario picture based on preset position point selection information, wherein the position point selection information comprises position information of at least one candidate position point in the first scenario picture.

17. The system according to claim 14, wherein, in response to detecting that the controlled virtual object in the first scenario picture is blocked by the first obstacle, determining the target position point from the first scenario picture comprises:
in response to detecting that the controlled virtual object in the first scenario picture is blocked by the first obstacle, determining a display region blocking the first obstacle in the first scenario picture; and
determining the target position point in a region out of the display region.

18. The system according to claim 14, wherein before generating the virtual straight line based on the mapping point of the target position point in the virtual scenario and the position of the virtual camera in the virtual scenario, the operation further comprises:
determining a target plane region corresponding to the first scenario picture in the virtual scenario based on depth information of the first scenario picture;
determining a side ratio of the first scenario picture to the target plane region; and
determining the mapping point corresponding to the target position point from the target plane region based on a position of the target position point in the first scenario picture and the side ratio, wherein the position of the target position point in the first scenario picture is same as a position of the mapping point in the target plane region.

19. The system according to claim 18, wherein determining the target plane region corresponding to the first scenario picture in the virtual scenario based on the depth information of the first scenario picture comprises:
determining a virtual view frustum corresponding to the virtual camera, wherein the virtual camera is located at a first vertex of the virtual view frustum;
determining a target plane corresponding to the first scenario picture in the virtual scenario based on the depth information of the first scenario picture, wherein the target plane is perpendicular to an orientation direction of the virtual camera, and a perpendicular distance between the target plane and the virtual camera is determined based on the depth information of the first scenario picture; and
determining a region in the target plane that intersects with the virtual view frustum as the target plane region.

20. The system according to claim 14, wherein controlling, in response to detecting that the second obstacle is not present, the virtual camera to move based on the mapping point comprises:
generating, in response to detecting that the second obstacle is not present, a movement path of the virtual camera based on the mapping point and a current position of the virtual camera, wherein the movement path has a specified shape, and a distance between any point on the movement path and the controlled virtual object is larger than or equal to a specified distance between the virtual camera and the controlled virtual object; and
controlling the virtual camera to move along the movement path from the current position.

21. The system according to claim 20, wherein generating, in response to detecting that the second obstacle is not present, the movement path of the virtual camera based on the mapping point and the current position of the virtual camera comprises:
generating, in response to detecting that the second obstacle is not present, an arc-shaped movement path with the current position of the virtual camera as a starting point,
wherein the distance between any point on the movement path and the controlled virtual object is determined based on a first distance value between the current position and the controlled virtual object and a second distance value between a position of the mapping point and the controlled virtual object.
